(19) United States
(12) Patent Application Publication
(10) Pub. No.: US 2010/0332195 A1
(43) Pub. Date: Dec. 30, 2010

(54) MULTI-PURPOSE OPTIMIZATION DESIGN SUPPORT APPARATUS AND METHOD, AND RECORDING MEDIUM STORING PROGRAM

(75) Inventors: Hitoshi YANAMI, Kawasaki (JP); Hirokazu Anai, Kawasaki (JP); Hidenao Iwane, Kawasaki (JP); Tsuneo Nakata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/823,621

(22) Filed: Jun. 25, 2010

(30) Foreign Application Priority Data
Jun. 29, 2009 (JP) 2009-153554

(51) Int. Cl. G06F 17/50

(52) U.S. Cl. 703/1

(57) ABSTRACT

A design support apparatus includes a parameter set generation unit configured to obtain a plurality of types of parameters and sequentially generates parameter sets while sequentially changing each parameter, a design object shape data generation unit configured to generate design object shape data based on the parameter set and initial shape data representing an initial shape of the design object shape, a geometric penalty function value calculation unit configured to calculate a geometric penalty function value indicating suitability of geometric characteristics of the design object shape based on the design object shape data, an objective function calculation control unit configured to determine whether or not the parameter set is used to calculate an objective function based on the geometric penalty function value and an optimal value of the objective function, and an objective function calculation unit configured to calculate the objective function based on the parameter set.

### CROSS-REFERENCE TO RELATED APPLICATIONS

This application is based upon and claims the benefit of priority of the prior Japanese Patent Application No. 2009-153554, filed on Jun. 29, 2009, the entire contents of which are incorporated herein by reference.

### FIELD

The embodiments disclosed herein are related to a multi-purpose optimization design support technology used for design.

### BACKGROUND

As hard disks have come to have a higher density and capacity, the distance between a magnetic disk and a head has become increasingly small. A slider design preferably has little floating variation due to an altitude difference and a disc radial position.

As indicated by 901 in FIG. 9, a slider is disposed in a lower part of the tip end of an actuator 902 that is moved over a magnetic disk inside a hard disk, and the position of a head is calculated using the shape of the slider 901.

When determining an optimal floating performance of the slider 901, design conditions regarding shape parameters concerning fly height (903 of FIG. 9), roll (904), and pitch (905) that are related to the position of the head are expressed as functions (objective function or cost function) of those parameters, and the parameters are set with which the objective function is minimized. In this optimization, while changing several to several tens of types of parameter values, floating simulation calculations are performed with respect to a corresponding shape so as to calculate a floating cost, which is an objective function, in order to search for a shape for which the cost is decreased.

As parameters for determining a slider shape, for example, there are physical quantities denoted by p, q, and r in FIG. 10. A set of parameters is determined while changing these values in small steps, and a floating simulation calculation is performed for each parameter set. In this calculation, if each parameter is normalized so as to move in, for example, a range [0, 1], the search space becomes a unit hypercube, and one design object shape corresponds to one point within the search space. If various shapes are to be processed with one optimization, the number of parameter sets is increased, and the size of the search space is increased.

In a case where a slider shape is to be searched while specifying numerous details, the number of parameters (p, q, r, etc., of FIG. 10) reaches 10 to 20 or thereabouts, presenting a problem in that floating simulation calculations of 10,000 or more iterations are performed, the size of the search space becomes large, and much time is taken for optimization.

Here, if the number of parameter sets is increased, places that are meaningless even if examined in the search space, that is, parameter sets that cannot be adopted because cutting out the shape is very difficult or is not possible at the time of manufacture, occur.

For this reason, floating calculation incurring a calculation cost is wastefully performed.

### SUMMARY

According to a certain aspect of the invention, a multi-purpose optimization design support apparatus includes a parameter set generation unit configured to obtain a plurality of types of parameters and each item of range data indicating a range of a corresponding parameter and that sequentially generates parameter sets while sequentially changing each parameter in a range indicated by the range data, a design object shape data generation unit configured to generate design object shape data representing the design object shape based on the parameter set generated by the parameter set generation unit and initial shape data representing an initial shape of the design object shape, a geometric penalty function value calculation unit configured to calculate a geometric penalty function value indicating suitability of geometric characteristics of the design object shape based on the design object shape data, an objective function calculation control unit configured to determine whether or not the parameter set generated by the parameter set generation unit in such a manner as to correspond to the geometric penalty function value is used to calculate an objective function based on the geometric penalty function value and an optimal value of the objective function, the optimum value being obtained thus far, and an objective function calculation unit configured to substitute the parameter set determined by the objective function calculation control unit for the objective function and calculate the objective function.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an embodiment of a design support apparatus;

FIG. 2 illustrates an example of an operation flowchart illustrating a control process of an embodiment;

FIGS. 3A and 3B are first illustrations of a first definition example of a geometric penalty function;

FIGS. 4A, 4B, 4C, and 4D are second illustrations of the first definition example of a geometric penalty function;

FIGS. 5A and 5B illustrate a specific calculation example of a geometric penalty function value;

FIGS. 6A, 6B, and 6C illustrate a second definition example of a geometric penalty function;

FIGS. 7A, 7B, and 7C illustrate a definition example of a determination function;

FIG. 8 illustrates an example of the hardware configuration of a computer capable of realizing an embodiment;

FIG. 9 illustrates an example of a slider of a hard disk; and

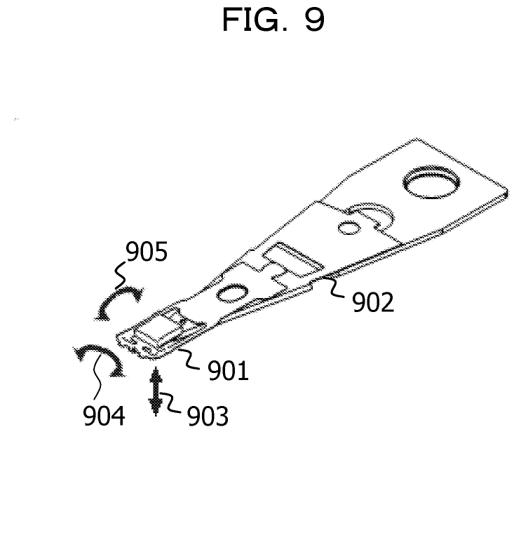

FIG. 10 illustrates an example of parameters of a slider shape.

### DESCRIPTION OF EMBODIMENTS

Embodiments will be described in detail below with reference to the drawings.

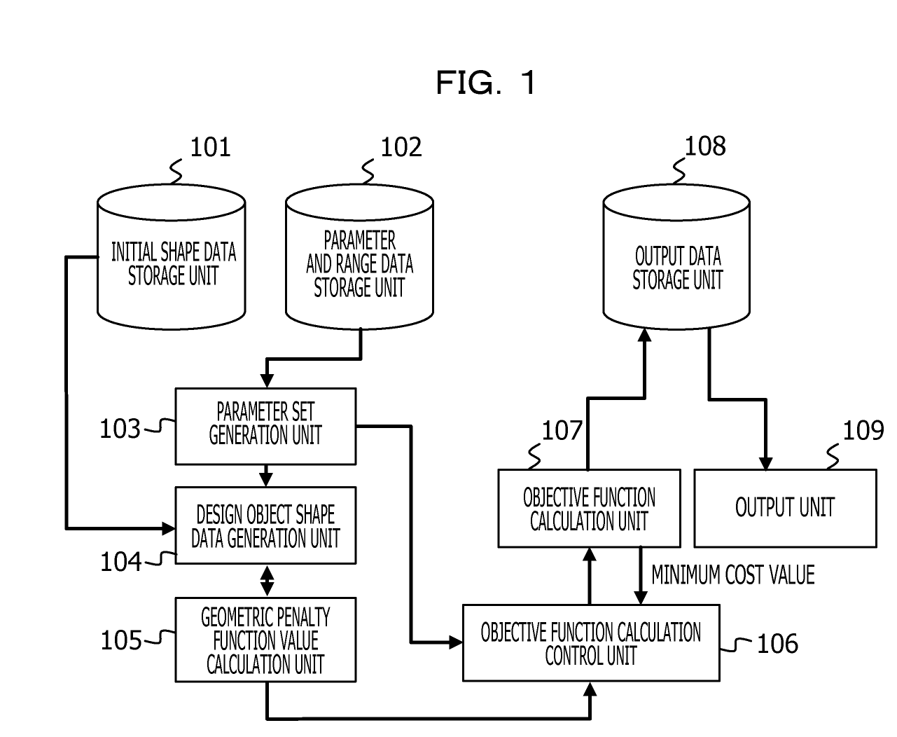

FIG. 1 is a configuration diagram illustrating an embodiment of a design support apparatus.

The present embodiment is realized as a design support apparatus that sequentially obtains parameter sets formed from a plurality of types of parameters for a design object shape, calculates an objective function based on a certain calculation, and supports the determination of an optimal design object shape and a parameter set corresponding to the design object shape based on the objective function. The design support apparatus has the following configuration.

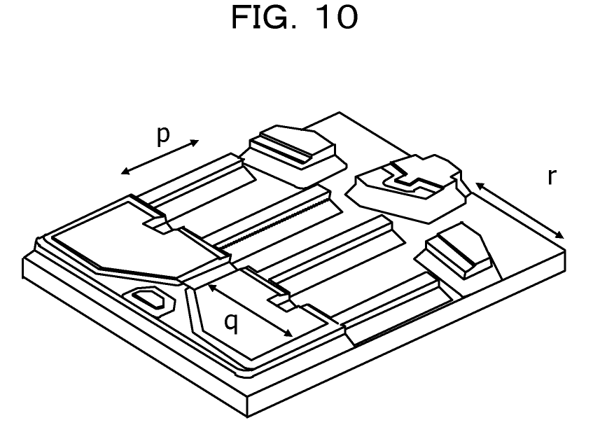

An initial shape data storage unit 101 stores an initial shape file of a slider shape (for example, a shape illustrated in FIG. 10), which is a design object shape.

A parameter and range data storage unit 102 stores a parameter file formed from a plurality of types of parameters (for example, p, q, r, etc., of FIG. 10) indicating a slider shape and range data indicating the range of each type of the parameters.

A parameter set generation unit 103 obtains a parameter file from the parameter and range data storage unit 102. Then, the parameter set generation unit 103 sequentially generates a parameter set while sequentially changing the value of each parameter in a range indicated by each item of the range data. That is, one parameter set is a set of a plurality of types of parameter values. A parameter set generation unit is used as a parameter set generation means.

A design object shape data generation unit 104 generates design object shape data representing a design object shape based on the parameter set generated by the parameter set generation unit 103 and the initial shape file read from the initial shape data storage unit 101. A design object shape data generation unit is used as a design object shape data generation means.

A geometric penalty function value calculation unit 105 calculates a geometric penalty function value indicating suitability of geometric characteristics of the design object shape based on the design object shape data generated by the design object shape data generation unit 104. A geometric penalty function value calculation unit is used as a geometric penalty function value calculation means.

An objective function calculation control unit 106 performs the following determination process based on the geometric penalty function value calculated by the geometric penalty function value calculation unit 105, and the optimal value of the objective function, the optimum value being obtained thus far by the objective function calculation unit 107, that is, the optimal cost value. That is, the objective function calculation control unit 106 determines whether or not the parameter set generated by the parameter set generation unit 103 in such a manner as to correspond to the geometric penalty function value is used for a calculation of the objective function in the objective function calculation unit 107. An objective function calculation control unit is used as an objective function calculation control means.

An objective function calculation unit 107 obtains the parameter set determined by the objective function calculation control unit 106, and performs a calculation of an objective function, that is, a floating cost calculation. An objective function calculation unit is used as an objective function calculation means.

When the objective function calculation unit 107 obtains an optimal cost value for which a designer satisfies, the optimal cost value is set as a minimum cost value, and is stored, together with the shape data and the parameter set that are used for the calculation, in an output data storage unit 108.

An output unit 109 processes data stored in the output data storage unit 108, and displays the optimal shape and the parameter set for the designer, or displays or prints out the relationship between the parameter set and the cost value (objective function value).

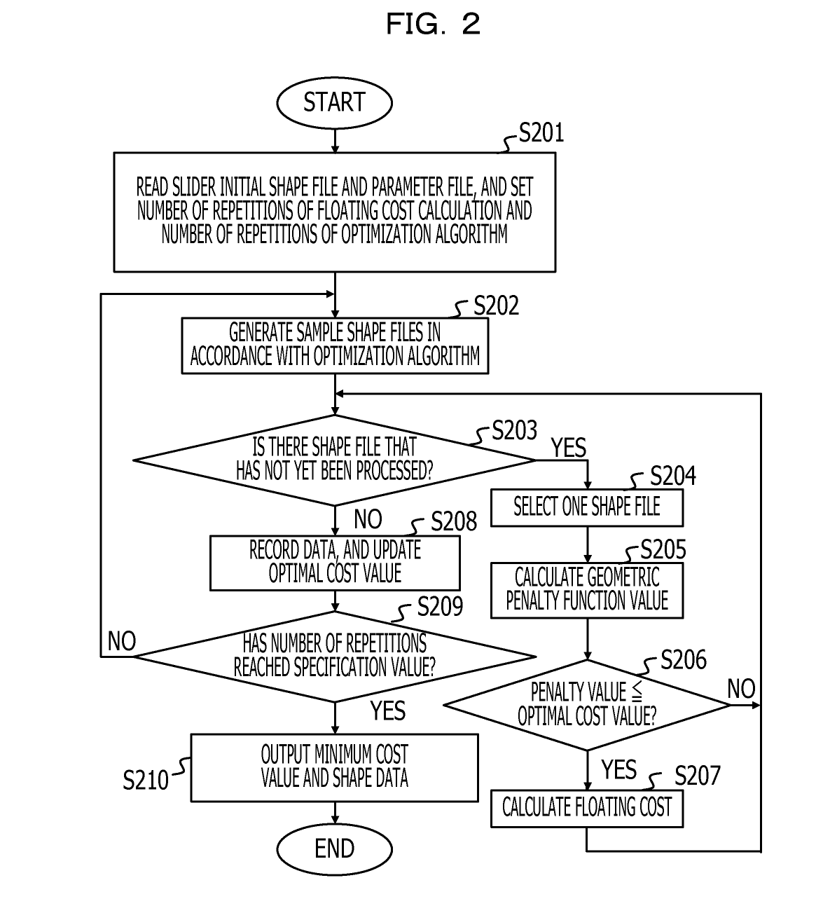

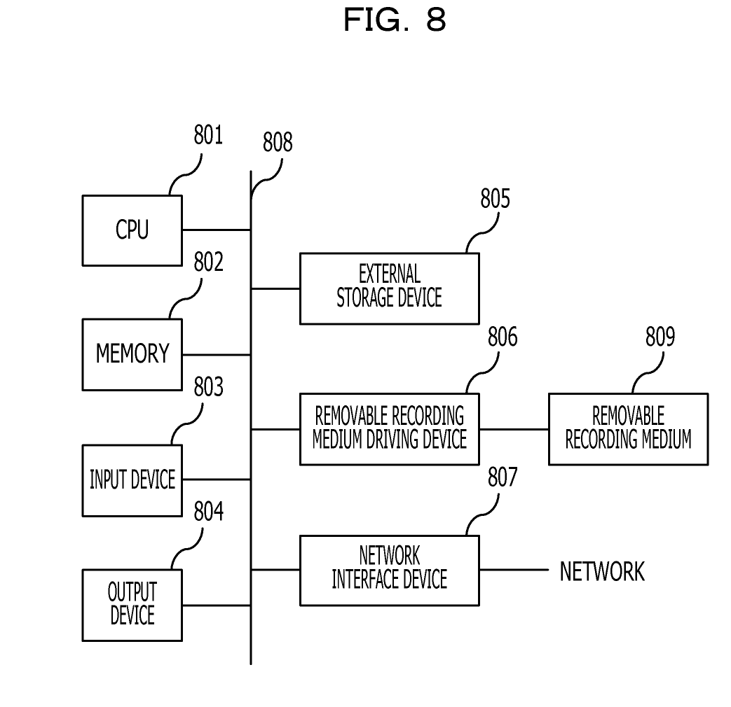

FIG. 2 is an operation flowchart illustrating a control process in a case where the configuration of FIG. 1 is implemented as a program process by a computer (see FIG. 8 to be described later).

A description will be given below, with reference to the operation flowchart of FIG. 2, of the detailed operation of the embodiment of FIG. 1.

First, an initial shape file of a slider is read from the initial shape data storage unit 101, and a parameter file is read from the parameter and range data storage unit 102. In addition, the number of repetitions of a floating cost calculation of S207 below, and the number of repetitions of an optimization algorithm process from S202 to S209 below are set by the designer (S201 of FIG. 2 in the foregoing).

Next, in accordance with a certain optimization algorithm, a plurality of parameter sets are generated while the value of each parameter in the parameter file is sequentially changed in the range indicated by each item of range data that is similarly in the parameter file. In addition, based on the generated parameter set and the initial shape file, a set of sample shape files (design object shape data) indicating a design object shape is generated (S202 of FIG. 2 in the foregoing). These processes correspond to the functions of the parameter set generation unit 103 and the design object shape data generation unit 104 of FIG. 1.

Next, sets of sample shape files generated in S202 are sequentially read, and it is determined whether or not there is a shape file that has not yet been processed (S203 of FIG. 2).

If there is a shape file that has not yet been processed and the determination of S203 is YES, one shape file that has not yet been processed is selected (S204 of FIG. 2).

Next, based on the shape file selected in S204, a geometric penalty function value indicating suitability of geometric characteristics of the slider shape is calculated (S205 of FIG. 2). This process corresponds to the function of the geometric penalty function value calculation unit 105 of FIG. 1. The details of this process will be described later.

Next, it is determined whether or not that the geometric penalty function value calculated in S205 is smaller than or equal to the optimal cost value obtained thus far by the floating cost calculation of S207 (S206 of FIG. 2). If the geometric penalty function value is greater than the optimal cost value and the determination of S206 is NO, the subsequent floating cost calculation is not performed, and the process returns to a process for selecting a shape file that has not yet been processed, which is subsequent to S203. On the other hand, if the geometric penalty function value is smaller than or equal to the optimal cost value and the determination of S206 is YES, the next floating cost calculation is performed. This process (S206 of FIG. 2) corresponds to the function of the objective function calculation control unit 106 of FIG. 1.

When the determination of S206 is YES, a floating cost calculation (simulation calculation) is performed (S207 of FIG. 2) by using the parameter set corresponding to the shape file that is being currently selected. This process corresponds to the function of the objective function calculation unit 107 of FIG. 1. After this calculation is completed, the process returns to the process for selecting a shape file that has not yet been processed, which is S203.

The series of processes from S204 to S207 are repeatedly performed for each shape file that has not yet been processed. These processes may be simultaneously performed with respect to a plurality of sets of shape files by distribution calculation in a case where there are two or more central processing units (CPUs) of a computer. When it is determined in S203 that there is no shape file that has not yet been processed, the following processing is performed.

The optimal cost value obtained thus far by the floating cost calculation of S207 is updated and stored in an internal memory (S208 of FIG. 2).

After that, it is determined whether or not the number of repetitions of the optimization algorithm has reached a value specified in S201 (S209 of FIG. 2). If the number of repetitions of the optimization algorithm has not reached the specified value and the determination of S209 is NO, the process returns to the process of S202, where a plurality of sets of new sample shape files are selected, and a series of processes similar to the foregoing are performed. When the number of repetitions of the optimization algorithm reaches the specified value and the determination of S209 becomes YES, the optimal cost value that has been obtained finally is set as a minimum cost value and is output, together with the slider shape data corresponding to the value to the output data storage unit 108 of FIG. 1 (S210 of FIG. 2).

Here, the above-described geometric penalty function value calculation process of S205, that is, the function of the geometric penalty function value calculation unit 105 of FIG. 1, will be described in detail.

In the optimization process for a design object shape illustrated in FIG. 2, the time taken for the floating cost calculation of S207 is dominant.

Therefore, in the present embodiment, the geometric characteristics of the design object shape are determined in such a manner as to correspond to the specified range of each parameter value. More specifically, for example, in a slider shape (see FIG. 10), a group of apexes to be moved in synchronization, a group of apexes to be moved subordinately, such as apexes whose motion is limited by the position of another apex, or the like, are extracted and determined, so that a “penalty” is attached to a badly-formed shape. More specifically, as will be described later, a geometric penalty function such as one in which the numerical value increases with respect to an undesirable apex arrangement is defined and calculated. Then, in a case where the geometric penalty function value is greater than the optimal cost value that has been obtained thus far by the floating cost calculation, it is determined in S206 of FIG. 2 that the shape is difficult to adopt because cutting out of the shape is very difficult or not possible at the time of manufacture, and the floating cost calculation is omitted.

In order that the above-described process may be realized, first, when a parameter file is read in S201 of FIG. 2, a geometric penalty function is defined.

For this purpose, first, the positional relationship among unsuitable apexes such as those described above in the slider shape is expressed by an algebraic expression (inequality expression), and a logical expression of the apex coordinates.

Here, the term “island”, such as in “an island that is concave”, “an island that is too pointed”, “the area and the width of an island are too small”, and “the spacing between islands is too narrow”, refers to a portion in which the height of the slider surface is high in the slider shape illustrated in FIG. 10.

Next, based on the logical expression, the geometric penalty function is defined in such a manner as to correspond to the degree of undesirability. In particular, the geometric penalty function is defined in such a manner that the geometric penalty function value diverges in such a manner as to correspond to the apex arrangement in which a floating cost calculation becomes unnecessary.

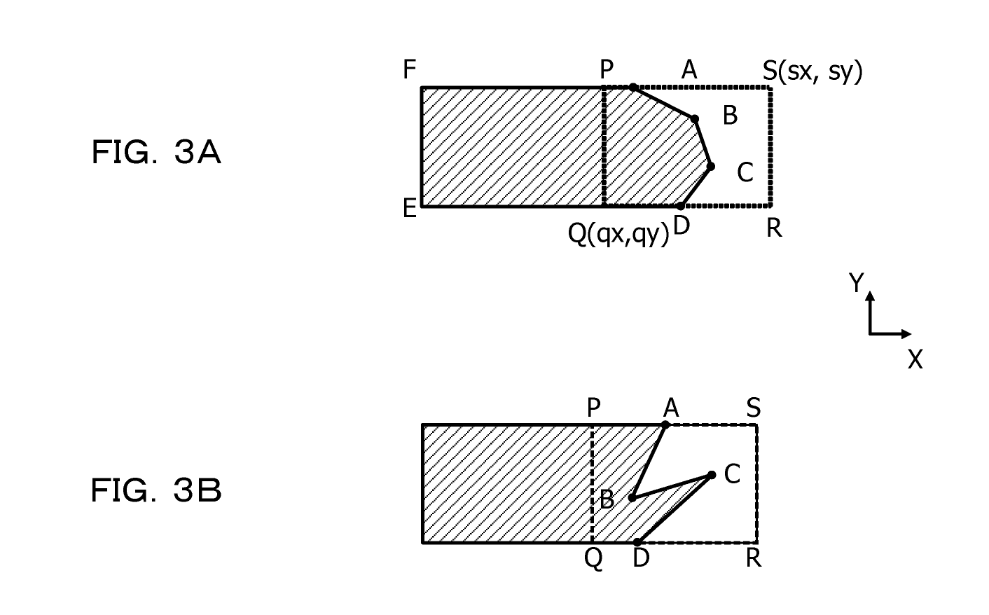

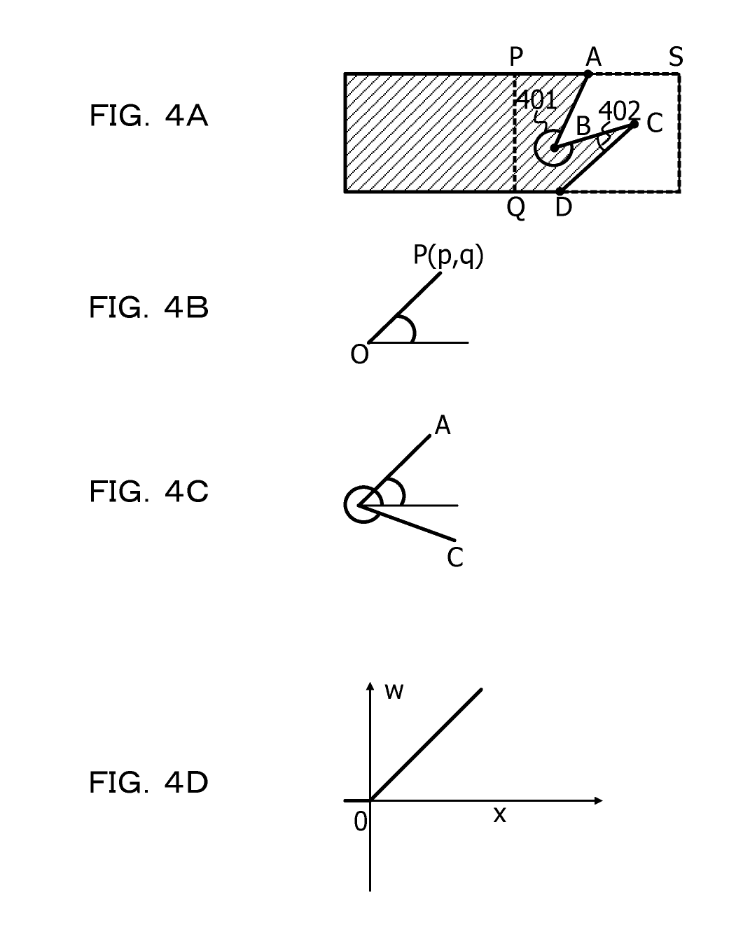

FIGS. 3A and 3B and FIGS. 4A to 4D are illustrations of a first definition example of a geometric penalty function.

The shading portions in FIGS. 3A and 3B illustrate an example of one island of a slider shape, and it is assumed that the positions of four apexes A, B, C, and D can be changed.

First, an apex A moves in a line segment PS, that is,

qx≦Ax≦sx

where Ax denotes the x coordinate value of the apex A, qx denotes the x coordinate values of the apexes P and Q, and sx denotes the x coordinate value of the apex S.

Next, the apexes B and C move inside a rectangle PQRS, that is,

qx≦Bx≦sx,

qy≦By≦sy,

qx≦Cx≦sx, and

qy≦Cy≦sy

where Bx and By denote the x and y coordinate values of the apex B, respectively, Cx and Cy denote the x and y coordinate values of the apex C, respectively, qy denotes the y coordinate value of the apex Q, and sy denotes the y coordinate value of the apex S.

Furthermore, the apex D moves in the line segment QR, that is,

qx≦Dx≦sx

where Dx denotes the x coordinate value of the apex D.

Here, FIG. 3A illustrates an example of the arrangement of parameters for which the designer wants to calculate the floating cost, and the apex ABCDEF forms a convex hexagon.

Additionally, FIG. 3B illustrates an example of the arrangement of parameters in which even if the floating cost value is good, it may be unnecessary to consider that cutting out is difficult at the time of manufacture. Since the internal angle ABC of the hexagon of the gray portion is greater than a π radian, the gray portion forms a concave hexagon.

Geometric penalty functions in which these geometric relationships are reflected are defined as illustrated in FIGS. 4A, 4B, 4C, and 4D.

In FIG. 4A, first,

r1=angle ABC (rad) (401 of FIG. 4A),

r2=angle BCD (rad) (402 of FIG. 4A). The unit (rad) is a radian.

Furthermore, a function w(x) is defined as follows.

w(x)=0 (when x<0)

w(x)=x (when x≧0)

By using r1, r2, and w(x) described above, a geometric penalty function p(A, B, C, D) regarding the apexes A, B, C, and D is defined by the following expression.

P(A,B,C,D)=k1×w(r1−π)+k2×w(r2−π)

where k1 and k2 are each a non-negative constant, and π is the ratio of the circumference of a circle to its diameter.

For example, r1 (angle ABC) described above can be calculated in the following manner. Now, the angle of a straight line OP illustrated in FIG. 4B from the horizontal line can be calculated in accordance with a relational expression tan(θ)=q/p. Here, “tan” is a tangent function. By considering the signs of p and q, 0≦θ<2π is uniquely determined. Next, when the angle of the straight line BC from the horizontal line is denoted as θ1 and the angle of the straight line BA from the horizontal line is denoted as θ2, the angle of the straight line BC when viewed from the straight line BA illustrated in FIG. 4C is θ2−θ1. Therefore, by calculating θ2−θ1 after θ1 and θ2 are calculated by the above expression, the angle of the straight line BC when viewed from the straight line BA, that is, the angle ABC=r1, can be calculated. However, when θ2−θ1 becomes negative, 2π is added. As a result, the result becomes greater than or equal to 0 and becomes less than 2π.

r2 (angle BCD) can also be calculated in a similar manner.

In S205 of FIG. 2, the geometric penalty function value defined in the manner described above is calculated from the apex data contained in the shape file.

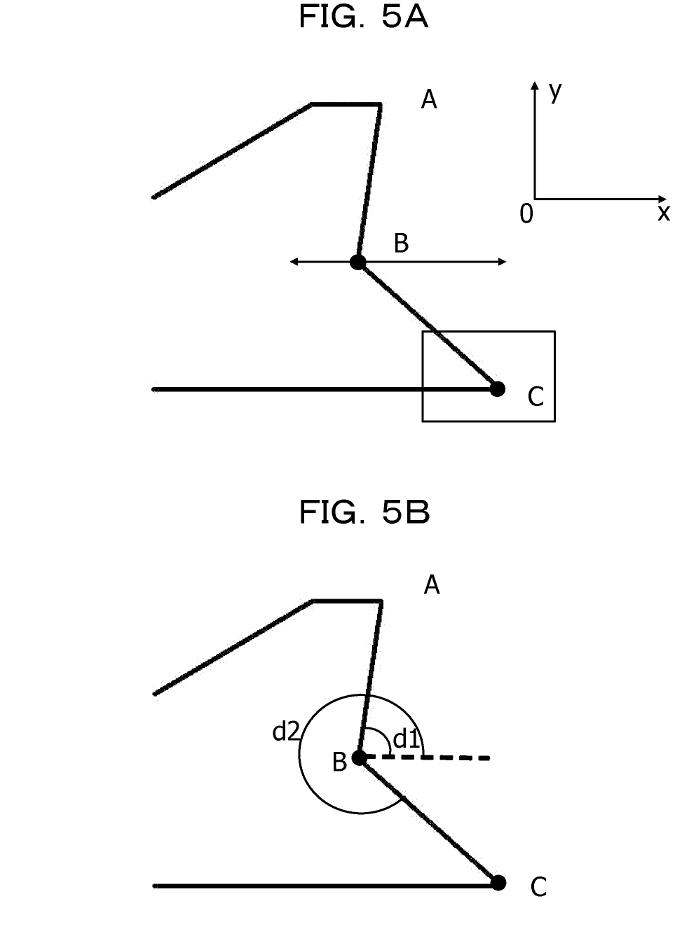

FIGS. 5A and 5B illustrate specific examples of calculation of a geometric penalty function value.

In FIG. 5A, the x coordinate of the apex B, the x coordinate of the apex C, and the y coordinate of the apex C among the three apexes A, B, and C are assumed to be parameters. As a result, the apex B moves to the left and right, and the apex C moves inside a rectangle.

Now, for example, each of the coordinate values described below of the apexes A, B, and C to be considered is extracted from the shape file.

A=[1.125474, 0.460000]

B=[1.117654, 0.407940]

C=[1.165348, 0.365605]

With respect to these values, the angles d1, d2, and d2−d1 illustrated in FIG. 5B, which are formed by the apexes, are calculated as follows.

Vector BA=[0.007820,0.052060]

Vector BC=[0.047694,−0.042335]

d1=1.421699740 (rad)

d2=5.557242253 (rad)

d2−d1=4.135542513 (rad)

The angle formed between the vector [x, y] and the horizontal line is calculated by arctan (y/x). However, when the point [x, y] is at second and third quadrants, π is added, and when the point [x, y] is at a fourth quadrant, 2π is added, so that the result becomes greater than or equal to 0 and less than 2π. Furthermore, in the case of x=0, if y>0, the angle is set to π/2, and if y<0, the angle is set to 3×π/2.

As a result, the geometric penalty function value is calculated as follows.

$$\begin{matrix}P ( A , B , C ) = 50 \times w ( 4.135542513 - π ) \\ = 49.69749295\end{matrix}$$

where the constant k is set at 50.

By using the geometric penalty function value such as that described above, the determination in S206 makes it possible to omit the floating cost calculation of S207 with regard to shapes that are difficult to manufacture or that are difficult to cut out because the manufacturing cost is high.

Furthermore, as a result of the geometric penalty function value being defined, it is possible to flexibly deal with, for example, a problem-free apex arrangement and an arrangement that can be accepted if the floating cost is very satisfactory.

Furthermore, in S206, by performing determination as to whether or not the floating cost calculation has been executed based on the geometric penalty function value and the optimal cost value thus far, control becomes possible in which the search arrangement space that can be accepted is narrowed as the cost value search progresses and the optimal cost value decreases.

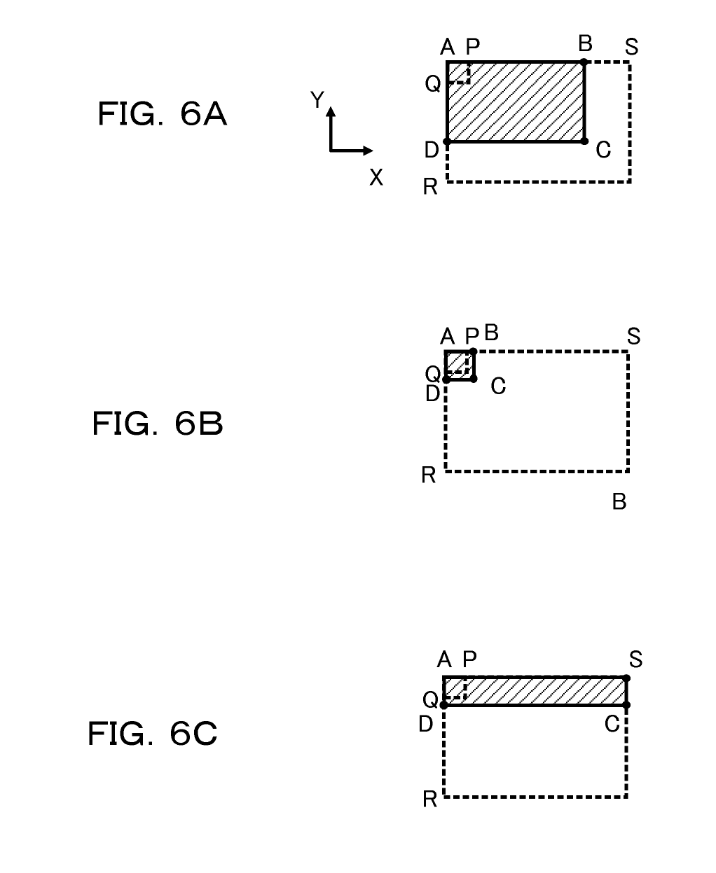

FIGS. 6A 6B, and 6C are illustrations of a second definition example of a geometric penalty function.

The shading portions of FIGS. 6A, 6B, and 6C represent an example of one island of a slider shape. It is assumed that the positions of the three apexes B, C, and D can be changed.

First, the apex moves in a line segment PS, that is,

qx≦Bx≦sx

where Bx denotes the x coordinate value of the apex A, qx denotes the x coordinate values of apexes P and Q, and sx denotes the x coordinate value of the apex S.

Next, the apex D moves in a line segment RQ, that is,

ry≦Dy≦qy

where Dy denotes the y coordinate value of the apex D, ry denotes the y coordinate value of the apex R, and qy denotes the y coordinate value of the apex Q.

In addition, the apex C moves in such a manner that the apexes ABCD forms a rectangle, that is,

Cx=Bx

Cy=Dy

where Cx and Cy are the x and y coordinate values of the apex C, respectively.

FIG. 6A illustrates an example of the arrangement of parameters with which the designer wants to calculate a floating cost, and also illustrates a case in which the area of an island formed from the apex ABCD has a sufficient size.

Next, FIG. 6B illustrates an example of the arrangement of parameters with which the designer does not want to calculate a floating cost, and also illustrates a case in which the area of an island is too small.

FIG. 6C illustrates an example of the arrangement of parameters with which the designer does not want to calculate a floating cost, and also shows a case in which the aspect ratio of an island is too large (may also be too small).

A geometric penalty function, though a specific example is omitted, in which a geometric relationship such as that described above is reflected, can be defined, making it possible to contribute to an efficient floating cost calculation.

In the above-described embodiment, whether or not the floating cost calculation of S207 of FIG. 2 is performed is determined based on the size relationship between the geometric penalty function value and the optimal cost value obtained thus far. However, depending on the design form, there is a case in which rather than excluding all the design object shapes in which the penalty is large, the design object shape is desired to be stochastically considered to a certain degree. Accordingly, in the following embodiment, a determination function is defined in which the greater the geometric penalty function value, the larger the degree in which the floating cost calculation is omitted becomes. Based on this, whether or not the floating cost calculation is executed is stochastically determined.

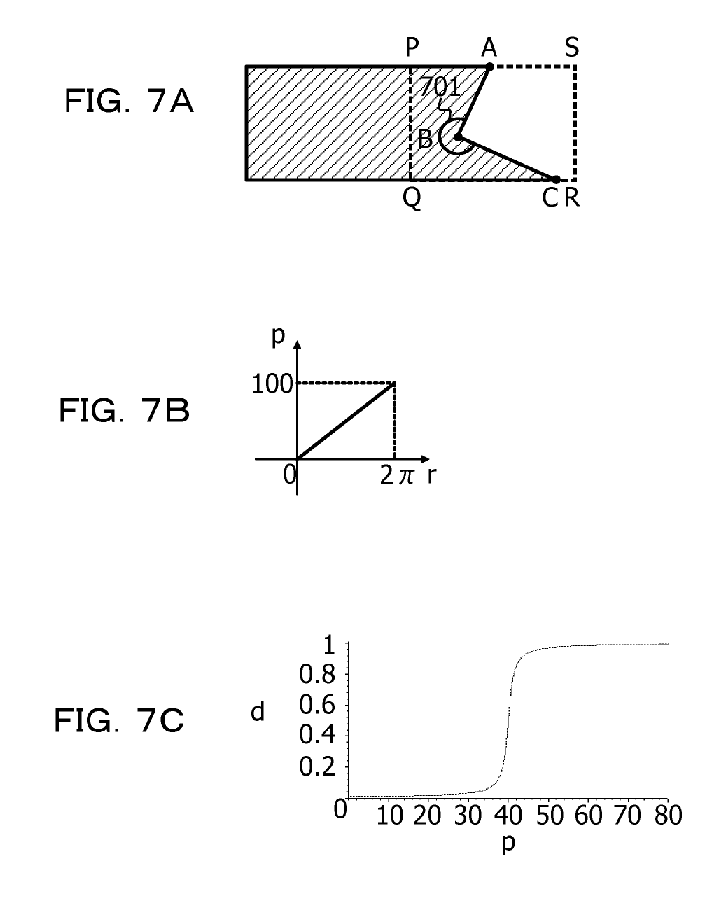

FIGS. 7A, 7B, and 7C are illustrations of an example of a definition of a determination function.

First, in FIG. 7A, the following angle is defined.

r=angle ABC (rad) (601 of FIG. 7A)

Based on this, a geometric penalty function p(r) is defined by the following expression.

p(r)=50×r/π

In this definition, unlike the case of the first definition example of the geometric penalty function described above, even if the portion formed by the apex ABC is convex, the penalty value is generated.

Next, by using a geometric penalty function value p, a determination function d is defined by the following expression.

d(p,m)=(1/π)×arctan(p−m/2)+1/2

where “arctan” is an inverse tangent function, and m denotes the optimal cost value in the search thus far.

FIG. 7C is a graph illustrating the relationship between a geometric penalty function value p and a determination function value d when m=80. As described above, it is possible to construct a scheme in which the larger the geometric penalty function value, the higher the probability in which the floating cost calculation is not performed becomes.

In S206 above, a determination is made as to whether or not the floating cost calculation has been executed based on the size relationship between the determination function value d and the optimal cost value thus far in place of the geometric penalty function value.

FIG. 8 illustrates an example of the configuration of the hardware of a computer that can realize the above-described embodiment.

A computer illustrated in FIG. 8 includes a CPU 801, a memory 802, an input device 803, an output device 804, and an external storage device 805, a removable recording medium driving device 806 into which a removable recording medium 809 is loaded, and a network interface device 807, all of which are interconnected with one another by a bus 808. The configuration shown in the figure illustrates an example of the computer that can realize the system, and such a computer is not limited to this configuration.

The CPU 801 performs control of the whole computer. The memory 802 is a memory, such as a RAM, for temporarily storing programs or data stored in a non-transitory computer readable recording medium such as the external storage device 805 (or removable recording medium 809) when a program is to be executed or data is to be updated. In above mentioned case, the non-transitory computer readable medium are internally packaged into computers such as ROMs and RAMS, the removable recoreding medium 809 such as flexible disks, DVD disks, magnet-optical disks and IC cards, the external storage device 805 such as database machines in which computer programs are held, other computer systems and database machines for use in the systems and various recording media built into other accessible computer systems. The CPU 801 reads a program into the memory 802, and executes the program, thereby performing control of the whole computer.

The input device 803 includes, for example, a keyboard, a mouse, and the like, and an interface control device therefor. The input device 803 detects an input operation using the keyboard, the mouse, and the like by a user, and notifies the CPU 801 of the detection result thereof.

The output device 804 includes a display device, a print device, and an interface control device therefor. The output device 804 outputs data that is sent under the control of the CPU 801 to the display device and the print unit.

The external storage device 805 is, for example, a hard disk storage device. The external storage device 805 is mainly used to store various data and programs.

The removable recording medium driving device 806 accommodates the removable recording medium 809, such as an optical disc, an SDRAM, or a compact flash (registered trademark), and functions to aid the external storage device 805.

The network interface device 807 is, for example, a device for connecting a communication line, such as a local area network (LAN) or a wide area network (WAN).

The system of the present embodiment is realized by executing a program by the CPU 801, the program having installed therein functions necessary for each processor of FIG. 1 or the control operation of the operation flowchart of FIG. 2. The programs may be recorded, for example, in the external storage device 805 or on the removable recording medium 809. Furthermore, the network interface device 807 may obtain programs from the network. The memory 802 may store the programs, or the external storage device 805 and the removable recording medium 809 may record the programs.

In the embodiments described thus far, the design object shape is a slider shape. Alternatively, the design object shape can be applied to various shapes.

The above-described embodiments relate to a cost calculation technology in a multi-purpose optimization design support technology or the like used to design a slider shape of a hard disk, and an objective function is made efficient in accordance with the design object shape.

In addition, by using a geometric penalty function value, calculation of an objective function for which the number of calculations is large can be omitted with regard to a shape for which cutting out is difficult because the manufacture thereof is difficult or the manufacturing cost is high.

Furthermore, as a result of defining a geometric penalty function value, it is possible to flexibly deal with, for example, a problem-free arrangement regarding a design object shape, an arrangement that can be accepted if the calculation value of the objective function is very satisfactory.

Furthermore, by performing a determination as to whether or not the floating cost calculation has been executed based on the geometric penalty function value and the optimal cost value thus far, control becomes possible in which the cost value search progresses and the search arrangement space that can be accepted is narrowed as the optimal cost value decreases.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterlation could be made hereto without departing from the spirit and scope of the invention.

What is claimed is:

1. A design support apparatus that calculates an objective function, and that supports a determination of a design object shape and a parameter set corresponding to the design object shape based on the objective function, the design support apparatus comprising:
a parameter set generation means for obtaining a plurality of types of parameters and each item of range data indicating a range of a corresponding parameter and sequentially generating parameter sets while sequentially changing each parameter in a range indicated by the range data;
a design object shape data generation means for generating design object shape data representing the design object shape based on the parameter set generated by the parameter set generation means and initial shape data representing an initial shape of the design object shape;
a geometric penalty function value calculation means for calculating a geometric penalty function value indicating suitability of geometric characteristics of the design object shape based on the design object shape data;
an objective function calculation control means for determining whether or not the parameter set generated by the parameter set generation means in such a manner as to correspond to the geometric penalty function value is used to calculate an objective function based on the geometric penalty function value and an optimal value of the objective function, the optimum value being obtained thus far; and
an objective function calculation means for substituting the parameter set determined by the objective function calculation control means for the objective function and calculate the objective function.

2. The design support apparatus according to claim 1, wherein, based on the size relationship between the geometric penalty function value and the optimal value of the objective function, the objective function calculation control means determines whether or not the parameter set generated by the parameter set generation means in such a manner as to correspond to the geometric penalty function value is used to calculate an objective function.

3. The design support apparatus according to claim 1, wherein, based on the size relationship between a determination function value that is stochastically determined from the geometric penalty function value and the optimal value of the objective function, the objective function calculation control means stochastically determines whether or not the parameter set generated by the parameter set generation means in such a manner as to correspond to the geometric penalty function value is used to calculate an objective function.

4. A design support method that calculates an objective function based on a certain calculation, and that supports a determination of an optimal design object shape and a parameter set corresponding to the design object shape based on the objective function, the design support method comprising:
obtaining a plurality of types of parameters and each item of range data indicating a range of a corresponding parameter and sequentially generating parameter sets while sequentially changing each parameter in a range indicated by the range data;
generating design object shape data representing the design object shape based on the generated parameter set and initial shape data representing an initial shape of the design object shape;
calculating, using a processor of a computer, a geometric penalty function value indicating suitability of geometric characteristics of the design object shape based on the design object shape data;
determining, using aprocessor of a computer, whether or not the generated parameter set in such a manner as to correspond to the geometric penalty function value is used to calculate an objective function based on the geometric penalty function value and an optimal value of the objective function, the optimum value being obtained thus far; and
substituting the determined parameter set for the objective function and calculating the objective function.

5. A non-transitory recording medium storing a program, the program causing a computer that calculates an objective function based on a certain calculation, and that supports a determination of an optimal design object shape and a parameter set corresponding to the design object shape based on the objective function to perform processing comprising:
obtaining a plurality of types of parameters and each item of range data indicating a range of a corresponding parameter and sequentially generating parameter sets while sequentially changing each parameter in a range indicated by the range data;
generating design object shape data representing the design object shape based on the generated parameter set and initial shape data representing an initial shape of the design object shape;
calculating, using a processor of a computer, a geometric penalty function value indicating suitability of geometric characteristics of the design object shape based on the design object shape data;
determining, using a processor of a computer, whether or not the generated parameter set in such a manner as to correspond to the geometric penalty function value is used to calculate an objective function based on the geometric penalty function value and an optimal value of the objective function, the optimum value being obtained thus far; and
substituting the determined parameter set for the objective function and calculating the objective function.

6. A design support apparatus that calculates an objective function, and that supports a determination of a design object shape and a parameter set corresponding to the design object shape based on the objective function, the design support apparatus comprising:
a processor that executes:
obtaining a plurality of types of parameters and each item of range data indicating a range of a corresponding parameter and sequentially generating parameter sets while sequentially changing each parameter in a range indicated by the range data;
generating design object shape data representing the design object shape based on the generated parameter set and initial shape data representing an initial shape of the design object shape;
calculating a geometric penalty function value indicating suitability of geometric characteristics of the design object shape based on the design object shape data;
determining whether or not the generated parameter set in such a manner as to correspond to the geometric penalty function value is used to calculate an objective function based on the geometric penalty function value and an optimal value of the objective function, the optimum value being obtained thus far; and
substituting the determined parameter set for the objective function and calculating the objective function.
